(19) United States
(12) Patent Application Publication
(10) Pub. No.: US 2009/0145190 A1
(43) Pub. Date: Jun. 11, 2009

(54) Method for improving plant growth and maintenance of drip irrigation systems

(76) Inventor: James Persinger, Hugoton, KS (US)

Correspondence Address: Frank Frisenda, Suite 200, 8275 South Eastern Avenue, Las Vegas, NV, 89123, US

(21) Appl. No.: 11/999,823

(22) Filed: Dec. 6, 2007

(51) Int. Cl. C05C 11/00

(52) U.S. Cl. 71/54

(57) ABSTRACT

Methods for improving plant growth and maintenance of drip irrigation systems are provided through the use of novel fertilizing solutions. The inventive method provides the plant with irrigating solution enriched with air, ozone, oxygen, and nitrogen oxides ions within a prescribed range. A gaseous mixture of negatively charged ionized air including from about 50 parts per million to about 4,000 parts per million ozone, from about 1,000 parts per million to 20,000 parts per million oxygen ions, and from 2,000 to about 50,000 parts per million nitrogen oxides is produced from ambient air. Thereafter, the gaseous mixture is directly contacted with water at the rate of from 0.1 cfm to about 2.0 cfm per 100 gpm of water to form a fertilizing solution containing nitrate ions in a concentration of at least 0.3 ppm by weight and containing ozone in a concentrate of at least 0.2 ppm. Accordingly, the novel irrigation solutions provide a healthier, and more vigorous plant growth with the combined benefit of minimizing internal scaling of drip irrigation system components.

### BACKGROUND OF THE INVENTION

The subject invention relates to methods for improving plant growth and maintenance of drip irrigation systems through the use of novel irrigation solutions. In more detail, the inventive method provides the plant with irrigating solution enriched with air, ozone, oxygen, and nitrogen oxides ions within a prescribed range, with the concurrent advantage of minimizing internal scale on components of the irrigation system.

It has been reported that fertilizer costs are the third highest input cost after land and machinery in crop production. The most common fertilizers used today are nitric acid-based fertilizers. These fertilizers are typically produced by processes that use the gas phase oxidation of nitric oxide (NO) to nitric dioxide (NO₂) and partially back to nitric oxide.

Many types of processes and industrial environments generate compounds containing nitrogen and oxygen, including nitrogen oxides. Any process which provides a sufficiently hot metal surface in contact with air can cause the formation of nitrogen oxides (usually as NO, NO₂, or N₂O₂), with the heated metal surface acting as a catalyst. Compounds containing nitrogen and oxygen (such as hydrazines) are also used in commerce or are produced as by-products in certain processes.

Nitric acid is a very important commercial product that is used as an intermediate in the manufacture of fertilizer. The production process uses the absorption of oxides of nitrogen into water and dilute acids. Because of this industrial need, the absorption process has been extensively examined for over a hundred years and in spite of this effort, the complex chemistry is not fully understood. There have been many theories proposed to describe transport from the gas phase to the final product. Reactions that relate to the oxidizer scrubber process, the absorption processes, and the effects of hydrogen peroxide have been summarized in U.S. Pat. No. 6,641,638 B1, issued Nov. 4, 2003, entitled “Process for Nitrogen Oxide Waste Conversion to Fertilizer”. The disclosure of U.S. Pat. No. 6,641,638 B1 is hereby incorporated by this reference.

Drinkard, Jr. in U.S. Pat. No. 6,264,909, discloses a process involves reacting NO from a source of NOₓ with HNO₃ in the presence of N₂ to produce nitric trioxide (N₂₀₃) and water, and then reacting the nitric trioxide with oxygen and water to produce nitric acid. The NO₂ gas from the NOₓ is converted to nitric acid and NO by reacting with water, and the remaining NO product is then converted to nitric acid as described above.

In U.S. Pat. No. 5,697,187, the instant inventor disclosed a novel method for treatment of crops by an irrigation solution. In more detail, in one embodied form, the patented method comprises the steps of producing a gaseous mixture of ionized air with prescribed amounts of ozone, oxygen and oxygen ions and effecting direct contact between the ionized air gaseous mixture and a supply of water by means of a submicron injector to produce a gaseous solution for treatment of irrigation water to be applied to agricultural crops. Thus, by treating the crops during irrigation, the process is successful in stopping surface fungus and molds on plants above ground.

Since oxygen diffusion is 100,000 times slower in water than air, small increases in concentration can have a large effect on the amount of oxygen available for respiration. It is well known that nitrates and nitrogen dioxide are reduced to nitrogen gas through the action of denitrifying bacteria with the concurrent release of combined oxygen.

In soils, adequate exchangeable calciums (the active calcium) is necessary to maintain good soil structure. Total soil calcium content is not necessarily a good indicator of structural conditions that a soil may possess; so, many other factors must be taken into consideration. Soil structure and its particle size distribution determines porosity and the ability of the soil to hold and release water to growing plants in addition to the aeration (oxygenation) status. Thus, factors which affect soil structure are important variables in plant nutrition.

The rate of oxygen used by plant and microbe respiration in soil can be very large in comparison with the amount contained in the volume of soil usually occupied by root systems. Anaerobic conditions develop when roots and soil microbes use oxygen for respiration faster than it can enter the soil through its numerous interconnected soil pores and does not necessarily require that waterlogged conditions exist.

Various irrigation systems including drip irrigation devices have been previously developed. These devices, however, can be rendered ineffective by scaling of internal components, algae growth, and clogging of the emitters and fluid distribution elements. Thus, cleaning of irrigation lines and other components is frequently required to maintain proper flow and distribution to plants and trees.

U.S. Pat. No. 5,383,601 discloses a drip watering apparatus. The apparatus includes a reservoir having a bottom surface with a plurality of apertures, and a base for supporting and stabilizing the reservoir. The reservoir cover can be adapted with a perimeter overhang, which helps shade the reservoir from direct sun exposure. The disclosed apparatus also includes an outlet control system, comprising a support member formed from rigid material and having a plurality of apertures.

Many known irrigation systems comprise fluid lines and connectors used for assembling the above irrigation system. The connectors have a nipple part for connecting to the branch tubes and a base part for connecting to the holes in the distribution pipe. Typically, the system includes an outlet control means for regulating an amount of outgoing liquid from a liquid reservoir to the distribution lines and/or emitters.

Slow water flow in the distribution pipe can also occur by scaling of the internal components, algae growth and other build-up of debris. These conditions can be minimized by use of the novel irrigation solutions of the present invention without the use of chlorine or other environmental unfriendly chemicals.

The present invention improves upon the related art by promoting plant growth, while at the same time minimizing internal scaling, algae growth on the irrigation system components.

The present invention also improves upon the related art by permitting a user to employ an easily constructed, relatively inexpensive, and effective way to improve and maintain the growth of plants and trees with a virtually continuous flow of water and fertilizer and at the same time is environment friendly.

Numerous other objects of the present invention will be apparent to those skilled in this art from the following description wherein there is shown and described a preferred embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

### SUMMARY OF THE INVENTION

Methods for improving plant growth and maintenance of drip irrigation systems are provided through the use of novel irrigation solutions. In more detail, the inventive method provides the plant with irrigating solution enriched with air, ozone, oxygen, and nitrogen oxides ions within a prescribed range.

In a presently preferred embodiment, the inventive method comprises the steps of:
a) producing a gaseous mixture of negatively charged ionized air including from about 50 parts per million to about 4,000 parts per million ozone, from about 1,000 parts per million to 20,000 parts per million oxygen ions, and from 2,000 to about 50,000 parts per million nitrogen oxides from ambient air;
b) effecting direct contact between said gaseous mixture of ionized air derived from step a) and a supply of water;
c) continuing said contact between said gaseous mixture of ionized air described from step a) and said water supply at the rate of 0.1 cfm to 2.0 cfm per 100 gpm of water to form fertilizing solution containing at least one nitrate ion in a concentration from about 0.3 to about 1.4 ppm by weight; and containing ozone in a concentration of from about 0.2 to about 1.7 ppm by weight;
d) maintaining said fertilizing solution derived from step e) at pH of 6.0 and 11; and
(e) providing the resultant fertilizing solution to an irrigation system for delivery to plants.

The gas-liquid contact is preferably effected by a submicron injector. However, any known gas-liquid dispersion device (also known as a distribution) which can sufficiently disperse the gas and liquid for improving gas-liquid contact efficiency can be utilized. More particularly, a suitable gas-liquid dispersion device is a device for dispersing the gas and/or liquid (or causing them to contact with each other in certain cases) within a container as a reaction vessel, holding tank or the like.

Examples of the aforementioned gas-liquid dispersion device used when a gas forms a continuous phase includes a submicron injector, bubbler, spray nozzle, a notch trough type device, and perforated plates with or without weirs, in which a liquid is dispersed downward. On the other hand, examples used when a liquid forms a continuous phase includes a sparger ring mounted at a lower part of a reaction vessel, a sintering pipe, and a multi-hole office plate (or single-hold orifice plate) used as a perforated plate (or single-hole plate) which is mounted at a lower part of a bubble tower.

Thus, the present invention presents an irrigation method combining the economy, controllability and environmental friendliness of known drip-irrigation systems and an effective fertilizing solution for plant growth and maintenance.

### BRIEF DESCRIPTION OF THE DRAWING

FIG. 1 is a schematic block diagram of one embodied method for improving plant growth and maintenance by preparation of novel irrigation solutions comprising prescribed amounts of ionized air, ozone, oxygen, and nitrogen gases in accordance with the present invention; and

FIG. 2 is a cross-sectional view of one suitable ozone generator cell to produce the gaseous mixture in accordance with present invention.

### DESCRIPTION OF THE PREFERRED EMBODIMENTS

In a presently preferred embodiment, the inventive method comprises producing a gaseous mixture of negatively charged ionized air including from about 50 parts per million to about 4,000 parts per million ozone, from about 1,000 parts per million to 20,000 parts per million oxygen ions, and from 2,000 to about 50,000 parts per million nitrogen oxides from ambient air; effecting direct contact between said gaseous mixture of ionized air derived from step a) and a supply of water; and continuing said contact between said gaseous mixture of ionized air described from step a) and said water supply at the rate of 0.1 cfm to about 2.0 cfm per 100 gpm of water to form fertilizing solution having a nitrate concentration in a range from at least 0.3 ppm to about 1.4 ppm by weight, and an ozone concentration of from about 0.2 ppm to about 1.7 ppm by weight.

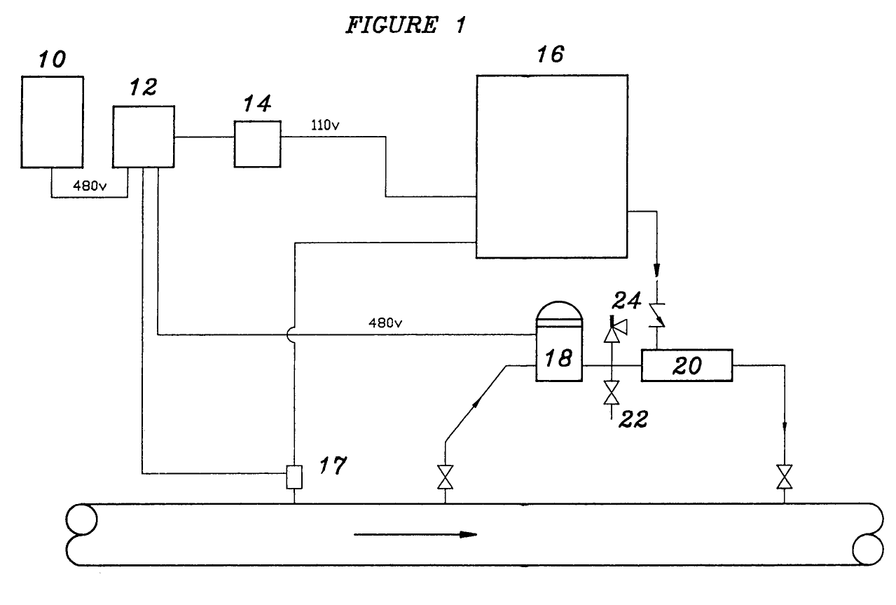

FIG. 1 depicts a schematic block diagram of one embodied method for treatment of plants by means of the inventive fertilizing solution comprising prescribed amounts of charged ionized air, ozone, oxygen, and nitrogen gases in solution in accordance with the present invention.

In more detail, as shown in FIG. 1, an irrigation sprinkler breaker 10 is provided with a disconnect and fuse box 12 and electrically connected to transformer 14 for activating and controlling the ionization unit 16. The ionization unit 16 produces a gaseous mixture of negatively charged ionized air including from about 50 parts per million to about 4,000 parts per million ozone, from about 1,000 parts per million to about 20,000 parts per million oxygen ions, and from about 2,000 to about 50,000 parts per million nitrogen oxides from ambient air.

From the ionization unit 16, a direct contact is effected between the gaseous mixture derived from unit 16 which is regulated by pressure sensor 17 and fed through pump 18 to aspirator 20. The direct contact of the gaseous mixture of ionized air derived from unit 16 is admixed with a supply of water by means of a gas-liquid contact apparatus to produce a fertilizing solution for treatment of plant life. The contact between the gaseous mixture of ionized air and the water supply is effected at a rate from about 0.1 cubic feet per minute to about 2.0 cubic feet per minute per 100 gallons per minute of water flow.

Conventional gas-liquid contact devices may be utilized such that a gas and a liquid are brought into mutual contact in a system in which the liquid forms a continuous phase to perform a chemical reaction, a heat exchange operation, dissipation, an absorption operation, and so on.

At an intake portion of the aforementioned gas-liquid contact apparatus, there is provided a gas-liquid dispersion device (also known as a distribution) which can sufficiently disperse the gas and liquid for improving gas-liquid contact efficiency. More particularly, the gas-liquid dispersion device is a device for dispersing the gas and/or liquid (or causing them to contact with each other in certain cases) at an intake portion of such containers such as a storage tank, a reaction vessel, a bubbler, an injector or the like.

Known examples of the aforementioned gas-liquid dispersion device used when a gas forms a continuous phase includes a spray nozzle, a notch trough type device, and perforated plates with or without weirs, in which a liquid is dispersed downward. On the other hand, examples used when a liquid forms a continuous phase includes a sparger ring mounted at a lower part of a reaction vessel, a sintering pipe, and a multi-hole office plate (or single-hold orifice plate) used as a perforated plate (or single-hole plate) which is mounted at a lower part of a bubbler.

As further shown in FIG. 1, for a pressurized system, the ionization unit 16 feeds the ionized air mixture to aspirator 20 which may be enhanced by means of booster pump 24 to achieve the desired end resultant solution.

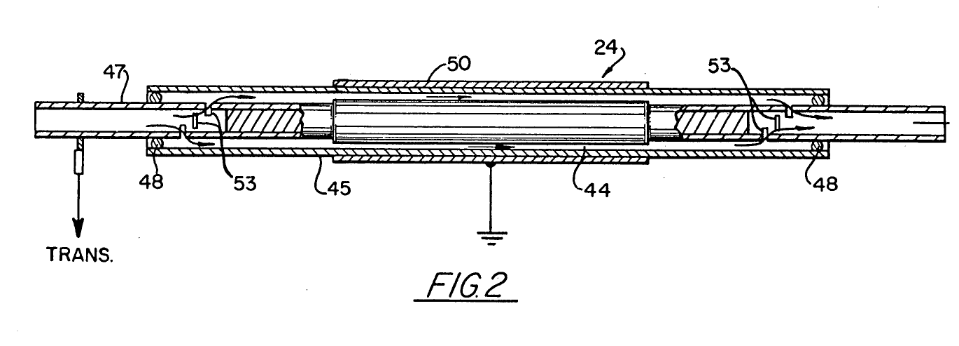

In more detail, one suitable ozone generator means is disclosed in U.S. Pat. No. 4,308,844 issued to James Persinger on Jan. 5, 1982. The apparatus, shown in FIG. 2, comprises an ozone generator cell 24 which acts on ambient air supply. The generator cell 24 produces ozone, oxygen and nitrogen oxides in the air supply. The generator cell 24 comprises metallic plates 47 and 50 disposed adjacent to one another and separated from each other by a dialectic material 45 and an air gap 44.

A potential is induced across the adjacent plates 47 and 50 causing negatively charged ionization of oxygen and nitrogen in the air flowing through the gap 44 which results in the production of ozone gas, nitrogen oxide and ionizing air particles.

In accordance with the present invention, the generator cell 24 produces ozone, oxygen and nitrogen oxides within the air supply and induces a charge of the mixture by applying an alternating potential of 15,000 volts across the plates 47 and 50. The potential across gap 44, alternating at a frequency in a range from about 60 to 400 cycles per second, produces ozone gas, nitrous oxide and adds a charge to the air supply.

As described above, the present invention may comprise multiple generator cells, preferably twelve, sequentially connected to produce the desired amount of ionized oxygen.

One suitable ignition transformer for use with the ozone cell is available from Dongan Electric Manufacturing Company of Detroit, Mich. The specifications for the preferred ignition transformer is from about 5,000 volts to about 15,000 volts and preferably, has 15,000 volts production at 60 cycle.

If the ambient air is excessively wet, or contained polluting particulants, an air filter may be used to remove excessive components prior to being fed into a compressor or air mover which flows the supply of air to the ozone generator cell.

Typically, the air supplied to the generator cells should have a minimum flow rate of about 0.5 to 4.0 cubic feet per minute per ozone generator cell. One suitable compressor for this purpose is commercially available from Gast Manufacturing of Bent Harbor, Mich.

In a further embodiment of the invention the fertilizing solution maybe custom blended, for example, to produce a solution having a relatively low pH. Such aqueous solution containing nitric acid may be used for a sufficient length of time to substantially reduce algae growth or to remove scaling of the system components.

In this embodiment, sufficient acid is usually present to provide a pH in the aqueous solution containing less about 7. However, if a system flush is desired at lower pH further acid can be added, as needed, to maintain the desired pH during the cleaning process.

The inorganic acid can be a strong inorganic acid, such as, hydrochloric acid, nitric acid, sulfuric acid, hydrobromic acid, hydriodic acid, perchloric acid, and chloric acid. A strong inorganic acid is an acid compound which ionizes completely or almost completely in aqueous solution. The inorganic acid can also be a weak inorganic acid, such as phosphoric acid and sulfurous acid.

The desired characteristics of the resultant fertilizing solution can of course be adjusted by blending in with the concentrated nitric acid, or caustic materials such as calcium carbonate to maintain a concentration level sufficient to produce the desired fertilizer products.

Accordingly, through the use of inventive solutions, drip irrigation systems and components such as their branching tubes with drip emitters can maintain uniform dripping with safeguarding substantial investment costs and power consumption in operation.

The methods of the present invention improves upon the related art by minimizing internal algae growth and scaling on the primary irrigation lines and elements. The present invention also improves upon the related art by permitting a user to employ an easily construed, relatively inexpensive, and effective way to water plants and trees.

Thus, the present invention presents an irrigation system combining the economy, controllability and environmental friendliness of known drip-irrigation systems.

Numerous other objects of the present invention will be apparent to those skilled in this art from the following description wherein there is shown and described a preferred embodiment of the present invention, simply by way of illustration of one of the modes best suited to carry out the invention. As will be realized, the invention is capable of other different embodiments, and its several details are capable of modification in various obvious aspects without departing from the invention. Accordingly, the drawings and description should be regarded as illustrative in nature and not restrictive.

Accordingly, the present invention achieves a higher quantity, healthier and more vigorous plant growth while at the same time providing an effective cleaning means for improving performance of irrigation systems.

I claim:

1. A method for improving growth and maintenance of plant life through the use of a fertilizer solution enriched with dissolved oxygen and nitrogen ions, the method comprising the steps of:
a) producing a gaseous mixture of negatively charged ionized air including from about 50 parts per million to about 4,000 parts per million ozone, from about 1,000 parts per million to 20,000 parts per million oxygen ions, and from 2,000 to about 50,000 parts per million nitrogen oxides from ambient air;
b) effecting direct contact between said gaseous mixture of ionized air derived from step a) and a supply of water;
c) continuing said contact between said gaseous mixture of ionized air described from step a) and said water supply at the rate of 0.1 cfm to 2.0 cfm per 100 gpm of water to form fertilizing solution of comprising nitrate ions in a concentration of from about 0.3 ppm to about 1.7 ppm weight and ozone in a concentration of from about 0.2 ppm to about 1.7 ppm by weight; and
(d) providing the resultant fertilizing solution to a distribution system to irrigate plants.

2. The method as defined in claim 1, wherein said gaseous mixture of ozone, oxygen and nitrogen oxides is produced by an ozone generator cell.

3. The method as defined in claim 1, wherein said gaseous mixture is produced by at least twelve generator cells sequentially connected to produce said gaseous mixture.

4. The method as defined in claim 1, wherein the direct contact defined in step b) is through use of a Mazzei submicron injector at a rate of 10 gpm to 130 gpm.

5. The method as defined in claim 1, wherein said fertilizing solution comprises at least 0.3 to 1.7 ppm by weight nitrate ions or nitrogen oxides.

6. The method as defined in claim 1, wherein said fertilizing solution has a pH level effective to minimize algae growth on components of an irrigation system.

7. The method as defined in claim 1, wherein said fertilizing solution has a pH level effective for cleaning internal surface components of an irrigation system.
